(19) United States
(12) Patent Application Publication
(10) Pub. No.: US 2024/0005664 A1
(43) Pub. Date: Jan. 4, 2024

(54) REDUCING FALSE ALARMS IN VIDEO SURVEILLANCE SYSTEMS

(71) Applicant: Robert Bosch GmbH, Stuttgart (DE)

(72) Inventors: Jan Karl Warzelhan, Bockhorn (DE); Chaitra Suresh, Munhall, PA (US); Pramod Anantharam, Mars, PA (US)

(21) Appl. No.: 17/856,599

(22) Filed: Jul. 1, 2022

(51) Int. Cl. G06V 20/52; G06V 20/40; G06V 10/82; G06T 7/20

(52) U.S. Cl. CPC G06V 20/52; G06V 20/44; G06V 10/82; G06T 2207/20084; G06T 2207/10016; G06T 2207/30232; G06T 2207/20081; G06T 7/20

(57) ABSTRACT

A video surveillance system for reducing false alarms. The video surveillance system includes a camera and an electronic processor. The electronic processor is configured to, when a moving object is detected in a video captured by the camera, perform object detection on the video to determine a score associated with a class of objects, using metadata associated with the video, determine a feature associated with the moving object detected in the video, and, using a machine learning algorithm, analyze the score associated with the class of objects and the feature associated with the moving object detected in the video, to determine whether the moving object detected in the video is a false alarm or a true alarm. The electronic processor is also configured to, when the moving object detected in the video is a true alarm, generate an alert.

### BACKGROUND

Currently, video surveillance systems are configured to trigger alarms when, for example, someone is detected moving inside a restricted area. A restricted area is an observed area under the surveillance of the video surveillance system. When an alarm is triggered, a notification or alert is sent to security personnel (for example, security operating center (SOC) personnel).

### SUMMARY

Video/image processing techniques that are traditionally used in video surveillance systems are capable of detecting movements in a video. Often, video/image processing techniques are highly sensitive to movement in order to ensure that every movement that could possibly pose a threat in the observed area is detected and triggers an alarm. However, this high sensitivity causes many false alarms to be triggered. For example, using video/image processing techniques that are highly sensitive to movement may cause a video surveillance system to trigger a true alarm when an intruder is crawling through grass but may also cause a video surveillance system to trigger a false alarm when the video surveillance system detects moving trees, rain drops on the camera lens, moving animals, and the like. False alarms may be up to 90 percent of the alarms triggered by a video surveillance system.

Today, there are surveillance systems which utilize deep neural nets (DNNs) to perform object detection in images. However, there are several disadvantages to using DNN object detection alone to determine whether an alert should be generated in a video surveillance system. One disadvantage is that intruders can easily fool video surveillance systems relying solely on object detection methods to trigger alarms. For example, if a video surveillance system is configured to trigger an alarm when a DNN determines that a person is in a restricted area, the video surveillance system may fail to trigger an alarm when a person covers themselves with a sheet of cardboard and moves in the restricted area.

Another disadvantage is that even state-of-the-art DNNs may fail to determine that an object belongs to a class of objects (for example, people or vehicles) due to training data that is not representative of one or more domains or one or more camera positions. A DNN may also fail to determine that an object belongs to a class of objects due to the quality of an image the DNN is analyzing (for example, an image taken in low light, a gray image, a thermal image, a noisy image, an image with a low number of pixels, an image with low resolution, and the like). These challenges may elevate the potential of false detection and misdetections.

Additionally, in traditional video surveillance systems certain areas monitored by a camera included in the video surveillance system may be what are referred to as “non-sensitive” areas where objects of interest may already be present (for example, parking lots where vehicles are parked). In non-sensitive areas it is desirable to have the video surveillance system generate an alert only when a detected object of interest is moving. In other words, the video surveillance system should not generate an alert when a stationary object of interest is detected in a non-sensitive area of an image. Other areas monitored by the camera may be “sensitive” areas. If an object of interest is present in a sensitive area, it is desirable that the video surveillance system generate an alert, whether or not the object of interest is moving. A DNN which is trained to identify static, non-moving objects may be sufficient to use to generate an alert for sensitive areas but will generate many false alarms in for non-sensitive areas. To avoid generating false alarms for non-sensitive areas, some instances described herein utilize a temporal DNN which is trained to identify moving objects and not detect static objects and some instances only analyze a video captured by the camera when movement is detected in the video. In some instances, a video is a video clip including one or more frames or images.

Aspects, features, and embodiments described herein provide, among other things, a system and a method for reducing false alarms in a video surveillance system. The suppression of true alarms can result in the unintended consequence of reducing false alarms in a video surveillance system. However, the aspects, features, and embodiments described herein also reduce the unintentional suppression of true alarms. To reduce false alarms in a video surveillance system, one aspect combines image-based object classification of a moving object using artificial intelligence (for example, DNNs) with features associated with the moving object. The features are determined using metadata from a video and describe aspects of an object's movement that are relevant to determining whether the movement of the object is associated with human activity.

One example provides a video surveillance system for reducing false alarms. The video surveillance system includes a camera and an electronic processor. The electronic processor is configured to, when a moving object is detected in a video captured by the camera, perform object detection on the video to determine a score associated with a class of objects, wherein the score represents a likelihood that the moving object detected in the video is associated with a class of objects, using metadata associated with the video, determine a features associated with the moving object detected in the video, and, using a machine learning algorithm, analyze the score associated with the class of objects and the feature associated with the moving object detected in the video, to determine whether the moving object detected in the video is a false alarm or a true alarm. The electronic processor is also configured to, when the moving object detected in the video is a true alarm, generate an alert.

Another example provides a method for reducing false alarms in a video surveillance system. The method includes, when a moving object is detected in a video captured by a camera, performing object detection on the video to determine a score associated with a class of objects, wherein the score represents a likelihood that the moving object detected in the video is associated with a class of objects, using metadata associated with the video, determining a feature associated with the moving object detected in the video, and, using a machine learning algorithm, analyzing the score associated with the class of objects and the feature associated with the moving object detected in the video, to determine whether the moving object detected in the video is a false alarm or a true alarm. The method also includes, when the moving object detected in the video is a true alarm, generating an alert.

Other aspects, features, and embodiments will become apparent by consideration of the detailed description and accompanying drawings.

### BRIEF DESCRIPTION OF THE DRAWINGS

FIG. 1 is a block diagram of a video surveillance system for reducing false alarms according to one example.

FIG. 2 is a flowchart of a method for reducing false alarms in video surveillance systems according to one example.

FIG. 3 illustrates an example image of an area under surveillance overlaid with metadata associated with a moving object.

FIG. 4 illustrates example pseudocode for a random forest algorithm.

FIG. 5 is a process flow diagram illustrating techniques that combine AI-based and metadata based object detection and classification.

FIG. 6 is an example graph illustrating the performance of certain systems and methods described herein relative to the performance of other, alternative, approaches.

### DETAILED DESCRIPTION

Before any aspects, features, or embodiments are explained in detail, it is to be understood that this disclosure is not intended to be limited in its application to the details of construction and the arrangement of components set forth in the following description or illustrated in the following drawings. Aspects, features, and embodiments are capable of other configurations and of being practiced or of being carried out in various ways.

A plurality of hardware and software based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more communication interfaces, one or more application specific integrated circuits (ASICs), and various connections (for example, a system bus) connecting the various components.

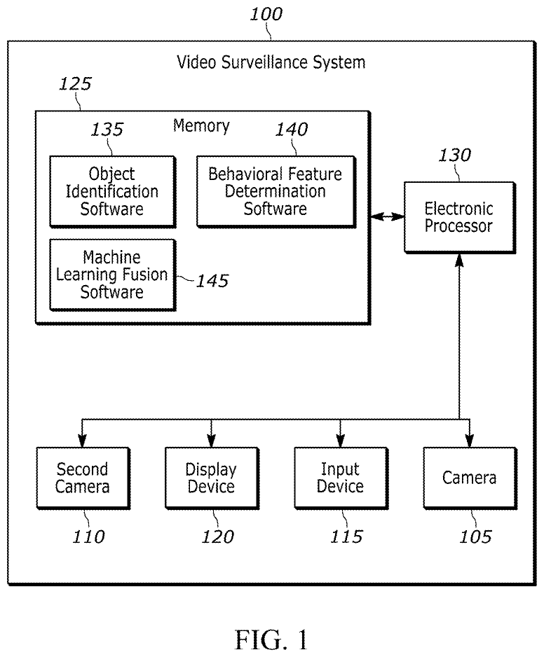

FIG. 1 illustrates one example of a video surveillance system 100 for reducing false alarms. The video surveillance system 100 includes a camera 105, a second camera 110, an input device 115, a display device 120, a memory 125, and an electronic processor 130. The display device 120 may include, for example, a touchscreen, a liquid crystal display (LCD), a light-emitting diode (LED), a LED display, an organic LED (OLED) display, an electroluminescent display (ELD), and the like. The input device 115 may include, for example, a keypad, a mouse, a touchscreen (for example, as part of the display device 120), a microphone, a camera, or the like (not shown). The electronic processor 130, memory 125, camera 105, second camera 110, input device 115, and display device 120 communicate wirelessly, over one or more communication lines or buses, or a combination thereof. It should be understood that the video surveillance system 100 may include additional components than those illustrated in FIG. 1 in various configurations and may perform additional functionality than the functionality described herein. In some instances, the video surveillance system 100 may include fewer components than those illustrated in FIG. 1. For example, the video surveillance system 100 may include only one camera (for example, the camera 105) or the functionality of the input device 115 and display device 120 may be combined into a single device.

The memory 125 includes object identification software 135, behavioral feature determination software 140, and machine learning fusion software 145. In some instances, the object identification software 135, behavioral feature determination software 140, and machine learning fusion software 145 include computer executable instructions which, when executed by the electronic processor 130, cause the electronic processor 130 to perform the functionality described herein. It should be understood that functionality described herein as being performed when multiple software components are executed by the electronic processor 130 may be performed by a single software component executed by the electronic processor 130. For example, the behavioral feature determination software 140 and machine learning fusion software 145 may combined into a single software component. It should be understood that the memory 125 may include additional components than those illustrated in FIG. 1 in various configurations and may perform additional functionality than the functionality described herein.

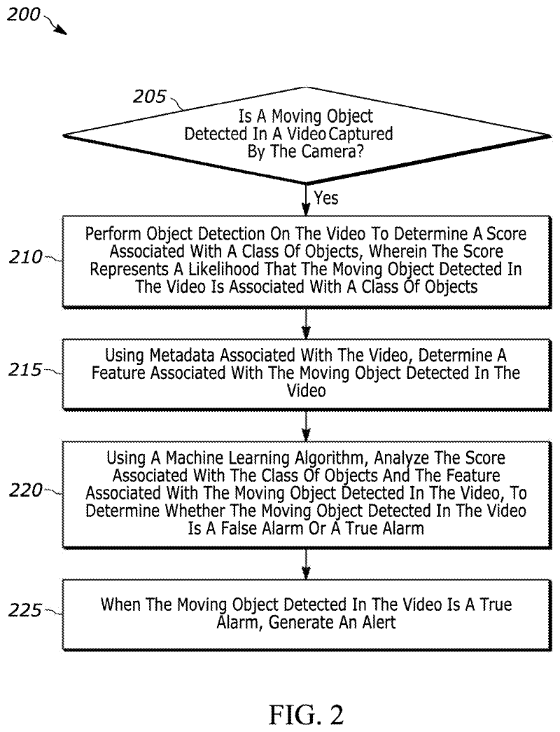

FIG. 2 illustrates a flowchart of an example method 200 for reducing false alarms in video surveillance systems (for example, the video surveillance system 100). The method 200 begins at block 205 when the electronic processor 130 detects a moving object in a video captured by the camera 105. When a moving object is detected in the video, at block 210, the electronic processor 130 performs object detection on the video to determine a score associated with a class of objects, wherein the score represents a likelihood that the moving object detected in the video is associated with a class of objects. For example, a first class of objects may be people, a second class of objects may be vehicles, and a third class of objects may be aerial drones. In one example, the video may include the movement that caused the electronic processor 130 to detect the moving object. In another example, the video may include a predetermined length of footage (for example, 5 seconds) before the time at which the electronic processor 130 detected the moving object and a predetermined length of footage (for example, 5 seconds) after the time at which the electronic processor 130 detected the moving object. In yet another example, the video may include a single frame (for example, the frame that was captured by the camera 105 at the moment the electronic processor 130 detected the moving object). In some instances, the electronic processor 130 uses a deep neural network (DNN) (for example, a convolutional neural network, a recurrent neural network, and the like) to perform object detection on the video. For example, based on the video, the DNN may determine a first score of 0.15 associated with a first class of objects (for example, vehicles) representing a 15 percent chance that the moving object is a vehicle and a second score of 0.75 associated with a second class of objects (for example, people) representing a 75 percent chance that the moving object is a person. In some instances, in addition to performing object detection on the video to determine a score associated with a class of objects, electronic processor 130 may also use the DNN to determine positions associated with the moving object over time and bounding boxes associated with the moving object over time.

At block 215, the electronic processor 130, using metadata associated with the video, determines a feature associated with the moving object detected in the video. In some instances, the metadata includes timestamped positions of the moving object, bounding boxes around the moving object, a trajectory of the moving object, and the like. In some instances, using metadata associated with the video, the electronic processor 130 determines a plurality of features associated with the moving object detected in the video. The features determined by the electronic processor 130 include, for example, at least one selected from the group consisting of (a) a displacement of the moving object over time, (b) a change in bounding box height associated with the moving object over time, (c) an average directional change of the moving object over time, (d) from a starting position of the moving object, a standard deviation of directional change of the moving object over time, (e) an average distance traveled by the moving object over time, (f) a standard deviation of a distance traveled by the moving object over time, (g) a difference in bounding box width between frames, (h) a difference in bounding box height between frames, (i) a mean absolute percentage error associated with fitting a line to direction values associated with the moving object over time, (j) a mean absolute percentage error associated with fitting a line to position values associated with the moving object over time, and (k) a mean absolute percentage error associated with fitting a line to distance values associated with the moving object over time. In other instances, the features determined by the electronic processor 130 may include fewer, additional, or different features than those described above. Using the features determined by the electronic processor 130, insights regarding the movement of the moving object may be determined, including (a) whether the movement of the moving object is smooth and continuous, (b) whether the size of the moving object is consistent when the moving object is not moving toward or away from the camera 105, (c) a linear transformation of bounding-box width and height between frames when the moving object is moving toward or away from the camera 105, (d) whether the moving object is moving in a consistent direction, and (e) whether the movement of the moving object is purposeful. These features are indicative of whether the movement is associated with human activity and, consequently, with a true alarm (for example, a vehicle or a person). For example, if the moving object remains the same size (the bounding box width and height stays the same) while seemingly moving towards the camera 105, the moving object is likely a false alarm (for example, a bug crawling on the lens or a raindrop trickling down the lens).

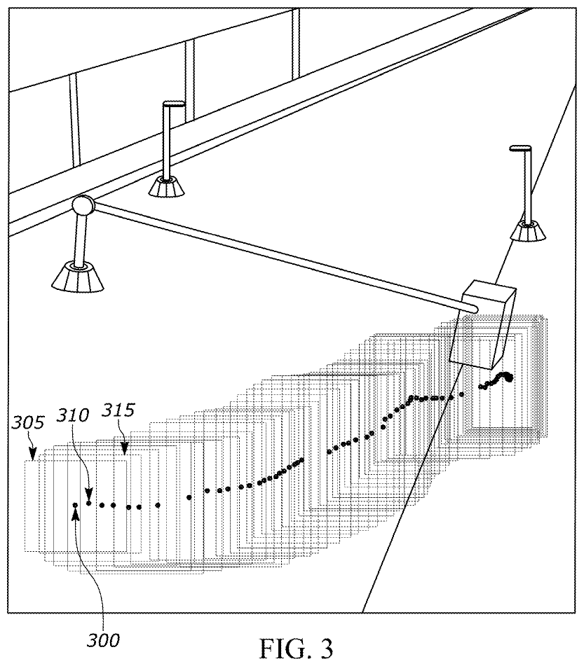

FIG. 3 illustrates an example image of an area under surveillance overlaid with metadata associated with a moving object which can be used by the electronic processor 130 to determine features associated with the moving object. The metadata may be in Open Network Video Interface Forum (ONVIF) Profile-M standard format, a proprietary format, or the like. For example, in FIG. 3, the metadata includes the position of the moving object over a plurality of frames of the video. Each (green) dot in FIG. 3 represents the position of the moving object in a frame. Each rectangle included in FIG. 3 represents the approximate portion of the surveillance area that the object occupies in a frame. In some instances, the position of the moving object is the center point of the bounding box. For example, a first dot 300 represents a first position of the moving object at a first time and a first bounding box 305 represents a first approximate portion of the surveillance area that the moving object occupies at the first time. A second dot 310 represents a second position of the moving object at a second time and a second bounding box 315 represents a second approximate portion of the surveillance area that the moving object occupies at the second time. The trajectory or direction of the moving object may be determined by fitting a line to the dots representing the positions of the moving object over time.

At block 220, the electronic processor 130 uses a machine learning algorithm, to analyze the score associated with the class of objects and the feature associated with the moving object detected in the video, to determine whether the moving object detected in the video is a false alarm or a true alarm. In some instances, the electronic processor 130 may also use the machine learning algorithm to analyze the positions associated with the moving object over time as determined using the DNN, the bounding boxes associated with the moving object over time as determined using the DNN, or both. In some instances, the electronic processor 130 may generate an overlap score and additionally analyze the overlap score with the machine learning algorithm. An overlap score may be determined based on the similarities between the positions associated with the moving object over time as determined using the DNN, the bounding boxes associated with the moving object over time as determined using the DNN, or both and the metadata based feature determined at block 215. In some instances, the machine learning algorithm is a random forest classifier. A random forest is a model ensemble approach to classification, regression analysis, and other types of problems, which builds multiple decision trees over randomly sampled training datasets. A random forest classifier performs well even when presented with outliers and noise. A random forest also provides an estimated error associated with the classification, an estimation of the strength or accuracy of individual trees, correlations between trees, and an estimate of the importance associated with each of a plurality of variables.

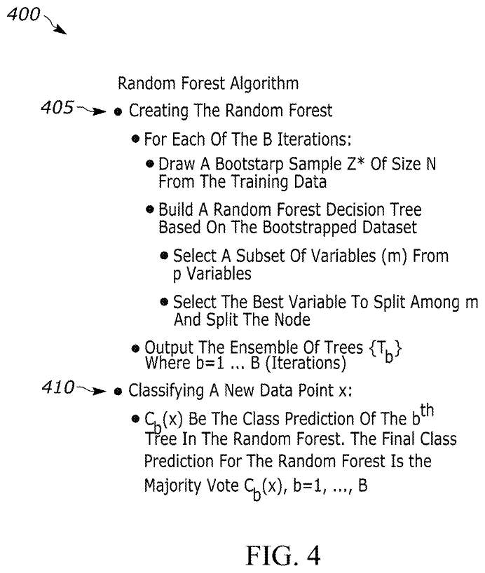

FIG. 4 illustrates example pseudocode 400 for a random forest algorithm. The first section 405 of the pseudocode 400 includes pseudocode associated with the creation of a random forest using training data. The “p variables” described in the pseudocode 400 may include the classes of objects to which the moving object may belong to and the features associated with the moving object detected in the video. Splitting a variable may refer to creating a new level of nodes in a decision tree in the forest. For example, a variable associated with the class of objects “people” may be represented by a first node. The first node may be split so that when a score input to the random forest and associated with the class of objects “people” is greater than 0.6, the electronic processor 130 selects a second node and when the score associated with the class of objects “people” is less than or equal to 0.6, the electronic processor 130 selects a third node. In another example, a variable associated with whether the size of the moving object is consistent when the moving object is not moving toward or away from the camera 105 (a feature) may be represented by a first node, and the first node may be split so that when the size of the moving object is consistent, the electronic processor 130 selects a second node and when the size of the moving object is inconsistent, the electronic processor 130 selects a third node. The second section 410 of the pseudocode 400 relates to classifying a moving object in a video (“a new data point x”). In classification problems, such as the one presented herein, majority voting is used to predict the class (in this case, false alarm or true alarm) the moving object in the video belongs to. For example, if 60 percent of the trees included in a random forest determine that the moving object in the video is a true alarm and 40 percent of the trees included in a random forest determine that the moving object in the video is a false alarm, the electronic processor 130 will determine that the moving object in the video is a true alarm.

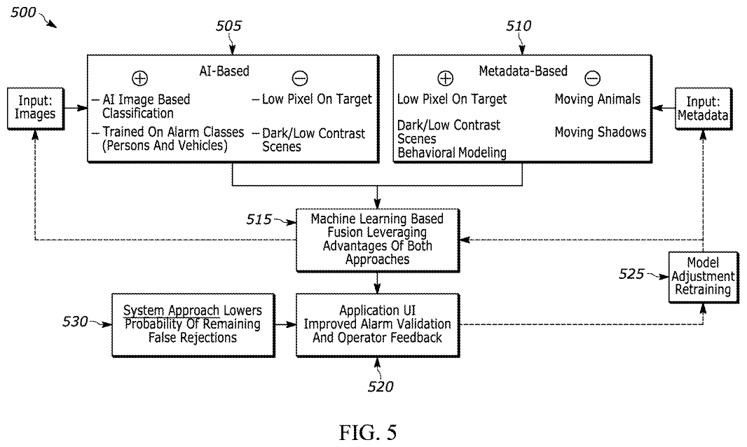

At block 225, the electronic processor 130 generates an alert when the moving object detected in the video is a true alarm. In some cases, the electronic processor 130 sends the generated alert to an output device (for example, the display device 120, a speaker, an LED light, a combination of the foregoing, or the like). In some instances, the electronic processor 130 sends the video along with the generated alert to the display device 120. The display device 120 displays the video along with the generated alert to allow security personnel to review the video. Based on their analysis of the video, the security personnel may provide feedback to the electronic processor 130 regarding the generated alert via the input device 115. For example, if the electronic processor 130 generated an alert based on a video that shows a tumbleweed blowing in the wind, security personnel may provide the feedback that video contains a false alarm. Based on the feedback received, the electronic processor 130 adjusts or retrains the DNN executed at block 210, the machine learning algorithm executed at block 220, or both. The retraining process is represented by the dashed lines in FIG. 5. In some instances, based on the received feedback, a software developer may adjust which metadata based features are analyzed by the electronic processor 130 using the machine learning algorithm.

In some instances, to minimize the number of true alarms that the electronic processor 130 fails to generate an alert for, the electronic processor 130 operates in a “high-alert mode” for a predetermined amount of time after a camera in the video surveillance system 100 captures a moving object that the electronic processor 130 determines to be a true alarm. For example, in some instances, the electronic processor 130, generates a second alert when a second moving object or the moving object is detected in a second video captured by the second camera 110 within a predetermined amount of time after the camera 105 captured the video and the moving object detected in the video is a true alarm. In other words, when the electronic processor 130 determines that a moving object captured by the camera 105 in a video surveillance system 100 is a true alarm and generates an alert, if another camera (for example, the second camera 110) in the video surveillance system 100 captures a moving object (for example, the moving object captured by the camera 105 or a different moving object) within a predetermined amount of time (for example, 30 minutes after the moving object is detected in the video captured by the camera 105), the electronic processor 130 generates an alert without performing the method 200 to determine whether the moving object captured by the second camera 110 is a false alarm. In another example, when a second moving object or the moving object is detected in a second video captured by the camera 105 a predetermined amount of time after the moving object is detected in the video and the moving object detected in the video is a true alarm, the electronic processor 130 generates a second alarm.

FIG. 5 is a process flow diagram 500 illustrating techniques that combine AI-based and metadata based object detection and classification. Block 505 includes some of the pros (listed under the “+”) and cons (listed under the “−”) of using artificial intelligence (AI) (for example, a DNN) to perform object detection to determine whether a moving object in a video is a true alarm or a false alarm. For example, a DNN may be able to classify whether the moving object is a vehicle or a person but may perform poorly when a video is dark, has low contrast, or is pixelated. As illustrated in FIG. 5, the input received by the DNN at block 505 is an image or images (for example, one or more frames included in a video). Block 510 includes some of the pros (listed under the “+”) and cons (listed under the “−”) of using metadata based features to determine whether a moving object in a video is a true alarm or a false alarm. For example, metadata based features are usually accurate when used to determine whether a moving object is a true alarm or a false alarm in a video that is dark, has low contrast, or is pixelated. However, metadata based features are usually less accurate at determining whether a moving object in a video is a true alarm or a false alarm when the moving object is an animal or a shadow. The input received at block 510 includes metadata from a camera included in the video surveillance system 100. The camera that the metadata is received from is the same camera that captured the images received at block 505.

The one or more scores generated by at block 505 and the features determined at block 510 are input to block 515. At block 515, the scores and the features are analyzed with the machine learning algorithm (by the electronic processor 130 executing the machine learning fusion software 145) to determine whether the moving object is true alarm or a false alarm. As described above, when the electronic processor 130 determines that the moving object is a true alarm, the electronic processor 130 generates an alert and send the alert to the display device 120. The display device 120 may display a visual representation of the alert, a video that caused the alert to be generated, or both via a software application user interface (UI) (represented by block 520 in FIG. 5). In some instances, security personnel may view the alarm and the video and decide whether the electronic processor 130 accurately determined whether the moving object included in the video is a false alarm or a true alarm. Based on their determination, security personnel may provide feedback. For example, security personnel may select a graphical user interface (GUI) button displayed on the display device 120 via, for example, the touch screen (for example, the input device 115) of the display device 120 when the security personnel determines that the moving object is a false alarm. As described above, the feedback from security personnel may be used to retrain the machine learning algorithm (represented by block 525 in FIG. 5). Block 530 of FIG. 5 represents the high alert mode of the video surveillance system 100 described above.

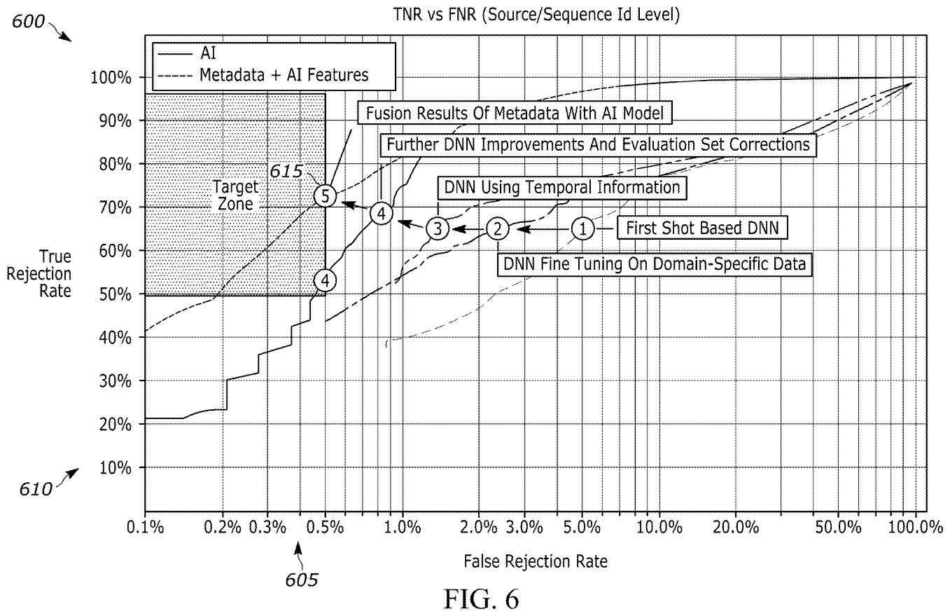

FIG. 6 is a graph 600 that illustrates the performance of the systems and methods described herein relative to the performance of other, alternative, approaches. The x-axis 605 of the graph 600 represents a false rejection rate or the percentage of true alarms that were incorrectly determined to be false alarms. The y-axis 610 of the graph 600 represents a true rejection rate or the percentage of false alarms that were correctly determined to be false alarms. The systems and methods described herein are represented by line 615. As illustrated in FIG. 6, the systems and methods described herein are capable of achieving a false rejection rate of less than 0.5 percent while maintaining a true rejection rate of more than 50 percent.

Thus, the aspects, features, and embodiments described herein provide, among other things, a video surveillance system and a method for reducing false alarms in a video surveillance system. Various features and advantages of the embodiments are set forth in the following claims.

What is claimed is:

1. A video surveillance system for reducing false alarms, the video surveillance system comprising:
a camera; and
an electronic processor configured to
when a moving object is detected in a video captured by the camera,
perform object detection on the video to determine a score associated with a class of objects, wherein the score represents a likelihood that the moving object detected in the video is associated with a class of objects;
using metadata associated with the video, determine a feature associated with the moving object detected in the video;
using a machine learning algorithm, analyze the score associated with the class of objects and the feature associated with the moving object detected in the video, to determine whether the moving object detected in the video is a false alarm or a true alarm; and
when the moving object detected in the video is a true alarm, generate an alert.

2. The video surveillance system according to claim 1, wherein the electronic processor is configured to perform object detection using a deep neural network.

3. The video surveillance system according to claim 1, wherein the machine learning algorithm is a random forest classifier.

4. The video surveillance system according to claim 1, wherein the feature associated with the moving object detected in the video is at least one selected from the group consisting of a displacement of the moving object over time, a change in bounding box height associated with the moving object over time, an average directional change of the moving object over time, from a starting position of the moving object, a standard deviation of directional change of the moving object over time, an average distance traveled by the moving object over time, a standard deviation of a distance traveled by the moving object over time, a difference in bounding box width between frames, a difference in bounding box height between frames, a mean absolute percentage error associated with fitting a line to direction values associated with the moving object over time, a mean absolute percentage error associated with fitting a line to position values associated with the moving object over time, and a mean absolute percentage error associated with fitting a line to distance values associated with the moving object over time.

5. The video surveillance system according to claim 1, wherein the feature associated with the moving object detected in the video is relevant to determining whether the moving object is associated with human activity.

6. The video surveillance system according to claim 1, the video surveillance system further comprising a display device and wherein the electronic processor is further configured to send the alert and the video to the display device.

7. The video surveillance system according to claim 1, the video surveillance system further comprising an input device and wherein the electronic processor is further configured to
receive, via the input device, feedback regarding the alert based on the video; and
based on the feedback, adjust the machine learning algorithm.

8. The video surveillance system according to claim 1, the video surveillance system further comprising a second camera and wherein the electronic processor is further configured to
when a second moving object or the moving object is detected in a second video captured by the second camera within a predetermined amount of time after the moving object being detected in the video and the moving object detected in the video is a true alarm, generate a second alarm.

9. The video surveillance system according to claim 1, wherein the electronic processor is further configured to
when a second moving object or the moving object is detected in a second video captured by the camera within a predetermined amount of time after the moving object being detected in the video and the moving object detected in the video is a true alarm, generate a second alarm.

10. The video surveillance system according to claim 1, wherein the metadata includes at least one selected from the group consisting of timestamped positions of the moving object, bounding boxes around the moving object, and a trajectory of the moving object.

11. A method for reducing false alarms in a video surveillance system, the method comprising:
when a moving object is detected in a video captured by a camera,
performing object detection on the video to determine a score associated with a class of objects, wherein the score represents a likelihood that the moving object detected in the video is associated with a class of objects;
using metadata associated with the video, determining a feature associated with the moving object detected in the video;
using a machine learning algorithm, analyzing the score associated with the class of objects and the feature associated with the moving object detected in the video, to determine whether the moving object detected in the video is a false alarm or a true alarm; and
when the moving object detected in the video is a true alarm, generating an alert.

12. The method according to claim 11, wherein performing object detection on the video to determine a score associated with a class of objects includes performing object detection using a deep neural network.

13. The method according to claim 11, wherein the machine learning algorithm is a random forest classifier.

14. The method according to claim 11, wherein the feature associated with the moving object detected in the video include at least one selected from the group consisting of a displacement of the moving object over time, a change in bounding box height associated with the moving object over time, an average directional change of the moving object over time, from a starting position of the moving object, a standard deviation of directional change of the moving object over time, an average distance traveled by the moving object over time, a standard deviation of a distance traveled by the moving object over time, a difference in bounding box width between frames, a difference in bounding box height between frames, a mean absolute percentage error associated with fitting a line to direction values associated with the moving object over time, a mean absolute percentage error associated with fitting a line to position values associated with the moving object over time, and a mean absolute percentage error associated with fitting a line to distance values associated with the moving object over time.

15. The method according to claim 11, wherein the feature associated with the moving object detected in the video is relevant to determining whether the moving object is associated with human activity.

16. The method according to claim 11, the method further comprising sending the alert and the video to a display device.

17. The method according to claim 11, the method further comprising
receiving, via an input device, feedback regarding the alert based on the video; and
based on the feedback, adjusting the machine learning algorithm.

18. The method according to claim 11, the method further comprising
when a second moving object or the moving object is detected in a second video captured by a second camera within a predetermined amount of time after the moving object being detected in the video and the moving object detected in the video is a true alarm, generating a second alarm.

19. The method according to claim 11, the method further comprising
when a second moving object or the moving object is detected in a second video captured by the camera within a predetermined amount of time after the moving object being detected in the video and the moving object detected in the video is a true alarm, generating a second alarm.

20. The method according to claim 11, wherein the metadata includes at least one selected from the group consisting of timestamped positions of the moving object, bounding boxes around the moving object, and a trajectory of the moving object.
